(19) United States
(12) Patent Application Publication
(10) Pub. No.: US 2018/0128530 A1
(43) Pub. Date: May 10, 2018

(54) REFRIGERATOR APPLIANCE AND ICE-MAKING ASSEMBLY THEREFOR

(71) Applicant: Haier US Appliance Solutions, Inc., Wilmington, DE (US)

(72) Inventor: Alan Joseph Mitchell, Louisville, KY (US)

(21) Appl. No.: 15/347,878

(22) Filed: Nov. 10, 2016

(51) Int. Cl. F25C 1/22; F25C 1/24; F25C 1/18; F25C 5/18; C02F 1/00; C02F 1/28; C02F 1/42

(52) U.S. Cl. CPC F25C 1/225; F25C 1/24; F25C 1/18; F25C 5/182; C02F 1/003; C02F 2101/30; C02F 1/42; F25C 2400/14; F25C 2400/12; F25C 2400/10; C02F 2001/427; C02F 1/283

(57) ABSTRACT

A refrigerator appliance and ice-making assembly are generally provided. The ice-making assembly may include an icemaker, an ice cube storage bin, a water reservoir, a water recirculation line, and a deionization filter. The icemaker may include a water distribution manifold and an ice formation panel. The ice cube storage bin may be in communication with the ice formation panel to receive ice cubes therefrom. The water reservoir may be positioned below the ice formation panel to receive excess water flow. The water recirculation line may be in fluid communication between the water reservoir and the water distribution manifold. The deionization filter may be positioned along the water recirculation line upstream from the water distribution manifold.

### FIELD OF THE INVENTION

The present subject matter relates generally to refrigerator appliances, and more particularly to refrigerator appliances having an ice-making assembly.

### BACKGROUND OF THE INVENTION

Certain refrigerator appliances include an icemaker. In order to produce ice, liquid water is directed to the icemaker and frozen. A variety of ice types can be produced depending upon the particular icemaker used. For example, certain icemakers include a mold body for receiving liquid water. Within the mold body, liquid water freezes to form ice cubes. Such icemakers can also include a heater and/or an auger for harvesting ice cubes from the mold body.

Freezing water within a mold body to form ice cubes has certain drawbacks. For example, ice cubes produced in such a manner can be cloudy or opaque, and certain consumers prefer clear ice cubes. In addition, harvesting ice cubes from the mold body with the heater and auger can be energy intensive such that an efficiency of an associated refrigerator appliance is decreased. Ice formation within the mold body can also be relatively slow such that maintaining a sufficient supply of ice cubes during periods of high demand is difficult. Further, icemakers with mold bodies can occupy large volumes of valuable space within refrigerator appliances.

Although some ice-making assemblies exist for creating relatively clear ice cubes, such systems often require regular addition and draining of water through the assembly. Some solids may be ejected from water during the formation of ice cubes. However, recirculating water risks concentrating dissolved solids within the system. These conditions may result in dirty, opaque, or cloudy ice cubes. Although dirty water may be replaced by fresh water, draining and replacing water can be wasteful and energy intensive. Moreover, merely filtering recirculated water may cause unwanted organic material to be introduced into the assembly.

Accordingly, an improved ice-making assembly for a refrigerator appliance with features for generating relatively clear ice cubes would be useful. In addition, an ice-making assembly for a refrigerator appliance that does not require a water supply to be constantly drained would be useful.

### BRIEF DESCRIPTION OF THE INVENTION

Aspects and advantages of the invention will be set forth in part in the following description, or may be obvious from the description, or may be learned through practice of the invention.

In one aspect of the present disclosure, an ice-making assembly for a refrigerator appliance is provided. The ice-making assembly may include an icemaker, an ice cube storage bin, a water reservoir, a water recirculation line, a deionization filter, and an organic compound filter. The icemaker may include a water distribution manifold and an ice formation panel. The ice cube storage bin may be in communication with the ice formation panel to receive ice cubes therefrom. The water reservoir may be positioned below the ice formation panel to receive excess water flow. The water recirculation line may be in fluid communication between the water reservoir and the water distribution manifold. The deionization filter may be positioned along the water recirculation line upstream from the water distribution manifold. The organic compound filter may be positioned along the water recirculation line in fluid communication between the deionization filter and the water distribution manifold.

In one aspect of the present disclosure, an ice-making assembly for a refrigerator appliance is provided. The ice-making assembly may include an icemaker, an ice cube storage bin, a water reservoir, a water recirculation line, a deionization filter, and a drain conduit. The ice-making assembly may include an icemaker, an ice cube storage bin, a water reservoir, a water recirculation line, a deionization filter, and an organic compound filter. The icemaker may include a water distribution manifold and an ice formation panel. The ice cube storage bin may be in communication with the ice formation panel to receive ice cubes therefrom. The water reservoir may be positioned below the ice formation panel to receive excess water flow. The water recirculation line may be in fluid communication between the water reservoir and the water distribution manifold. The deionization filter may be positioned along the water recirculation line upstream from the water distribution manifold. The drain conduit may extend in fluid communication between the ice cube storage bin and the evaporation pan.

In yet another aspect of the present disclosure, a refrigerator appliance is provided. The refrigerator appliance include a cabinet defining a chilled chamber, a door mounted to the cabinet, and an ice-making assembly mounted to the door. The ice-making assembly may include an icemaker, an ice cube storage bin, a water reservoir, a water recirculation line, a deionization filter, and an organic compound filter. The icemaker may include a water distribution manifold and an ice formation panel. The ice cube storage bin may be in communication with the ice formation panel to receive ice cubes therefrom. The water reservoir may be positioned below the ice formation panel to receive excess water flow. The water recirculation line is in fluid communication between the water reservoir and the water distribution manifold. The deionization filter may be positioned along the water recirculation line upstream from the water distribution manifold. The organic compound filter may be positioned along the water recirculation line in fluid communication between the deionization filter and the water distribution manifold.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures.

FIG. 1 provides a perspective view of a refrigerator appliance according to example embodiments of the present disclosure.

FIG. 2 provides a perspective view of a door of the example refrigerator appliance of FIG. 1.

FIG. 3 provides an elevation view of the door of the example refrigerator appliance of FIG. 2, with an access door of the door shown in an open position.

FIG. 4 provides a perspective view of an ice-making assembly according to an example embodiment of the present disclosure.

FIG. 5 provides a perspective view of the filtration cartridge of the example ice-making assembly of FIG. 3.

FIG. 6 provides a perspective cross-sectional view of the example filtration cartridge of FIG. 5.

FIG. 7 provides a schematic view of a water distribution assembly for a refrigerator appliance according to an example embodiment of the present disclosure.

FIG. 8 provides a schematic view of another water distribution assembly for a refrigerator appliance according to an example embodiment of the present disclosure.

### DETAILED DESCRIPTION

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment can be used with another embodiment to yield a still further embodiment. Thus, it is intended that the present invention covers such modifications and variations as come within the scope of the appended claims and their equivalents.

Generally, the present disclosure provides a refrigerator appliance and ice-making assembly that has an icemaker and a water reservoir that supplies water for the icemaker. The water reservoir receives excess water or runoff from the icemaker. A recirculation line connects the water reservoir to the icemaker so that water can be reused and returned to the icemaker. A deionization filter is positioned along the water recirculation line and may clean water as it is returned to the icemaker.

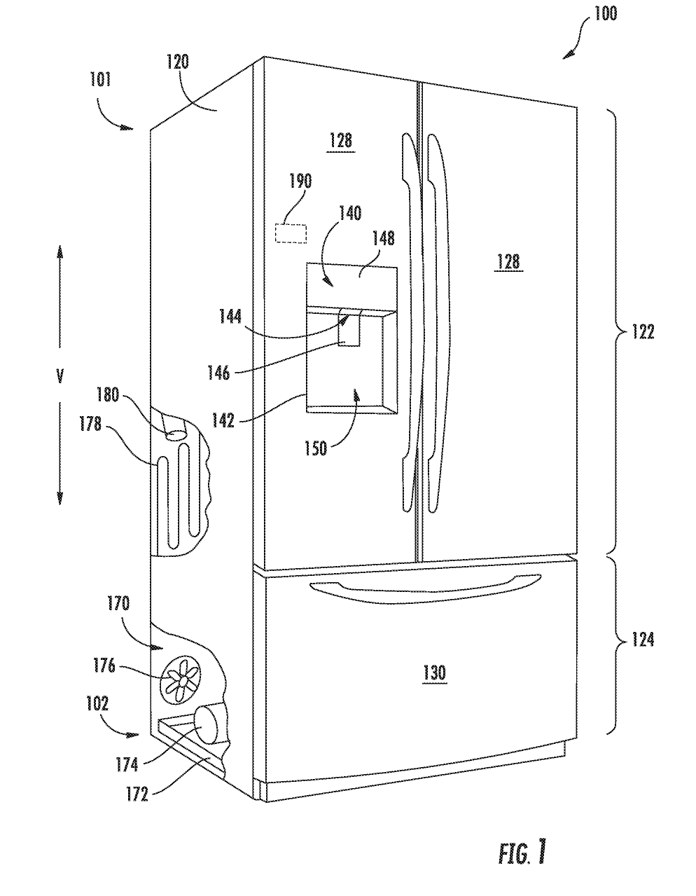

Turning now to the figures, FIG. 1 provides a perspective view of a refrigerator appliance 100 according to an exemplary embodiment of the present disclosure. Refrigerator appliance 100 includes a cabinet or housing 120 that extends between a top portion 101 and a bottom portion 102 along a vertical direction V. Housing 120 defines chilled chambers for receipt of food items for storage. In particular, housing 120 defines fresh food chamber 122 positioned at or adjacent top portion 101 of housing 120 and a freezer chamber 124 arranged at or adjacent bottom portion 102 of housing 120. As such, refrigerator appliance 100 is generally referred to as a bottom mount refrigerator. It is recognized, however, that the benefits of the present disclosure apply to other types and styles of refrigerator appliances such as, e.g., a top mount refrigerator appliance or a side-by-side style refrigerator appliance. Consequently, the description set forth herein is for illustrative purposes only and is not intended to be limiting in any aspect to any particular chilled chamber configuration.

Refrigerator doors 128 are rotatably hinged to an edge of housing 120 for selectively accessing fresh food chamber 122. In addition, a freezer door 130 is arranged below refrigerator doors 128 for selectively accessing freezer chamber 124. Freezer door 130 is coupled to a freezer drawer (not shown) slidably mounted within freezer chamber 124. Refrigerator doors 128 and freezer door 130 are shown in a closed configuration in FIG. 1.

Refrigerator appliance 100 also includes a dispensing assembly 140 for dispensing liquid water and/or ice. Dispensing assembly 140 includes a dispenser 142 positioned on or mounted to an exterior portion of refrigerator appliance 100, e.g., on one of doors 128. Dispenser 142 includes a discharging outlet 144 for accessing ice and liquid water. An actuating mechanism 146, shown as a paddle, is mounted below discharging outlet 144 for operating dispenser 142. In alternative exemplary embodiments, any suitable actuating mechanism may be used to operate dispenser 142. For example, dispenser 142 can include a sensor (such as an ultrasonic sensor) or a button rather than the paddle. A user interface panel 148 is provided for controlling the mode of operation. For example, user interface panel 148 includes a plurality of user inputs (not labeled), such as a water dispensing button and an ice-dispensing button, for selecting a desired mode of operation such as crushed or non-crushed ice.

Discharging outlet 144 and actuating mechanism 146 are an external part of dispenser 142 and are mounted in a dispenser recess 150. Dispenser recess 150 is positioned at a predetermined elevation convenient for a user to access ice or water and enabling the user to access ice without the need to bend-over and without the need to open doors 128. In the exemplary embodiment, dispenser recess 150 is positioned at a level that approximates the chest level of a user.

Operation of the refrigerator appliance 100 can be regulated by a controller 190 that is operatively coupled to user interface panel 148 and/or various other components, as will be described below. User interface panel 148 provides selections for user manipulation of the operation of refrigerator appliance 100 such as e.g., selections between whole or crushed ice, chilled water, and/or other various options. In response to user manipulation of user interface panel 148 or one or more sensor signals, controller 190 may operate various components of the refrigerator appliance 100. Controller 190 may include a memory and one or more microprocessors, CPUs or the like, such as general or special purpose microprocessors operable to execute programming instructions or micro-control code associated with operation of refrigerator appliance 100. The memory may represent random access memory such as DRAM, or read only memory such as ROM or FLASH. In one embodiment, the processor executes programming instructions stored in memory. The memory may be a separate component from the processor or may be included onboard within the processor. Alternatively, controller 190 may be constructed without using a microprocessor, e.g., using a combination of discrete analog and/or digital logic circuitry (such as switches, amplifiers, integrators, comparators, flip-flops, AND gates, and the like) to perform control functionality instead of relying upon software.

Controller 190 may be positioned in a variety of locations throughout refrigerator appliance 100. In the illustrated embodiment, controller 190 is located within the user interface panel 148. In other embodiments, the controller 190 may be positioned at any suitable location within refrigerator appliance 100, such as for example within a fresh food chamber, a freezer door, etc. Input/output (“I/O”) signals may be routed between controller 190 and various operational components of refrigerator appliance 100. For example, user interface panel 148 may be in communication with controller 190 via one or more signal lines or shared communication busses.

As illustrated, controller 190 may be in communication with the various components of dispensing assembly 140 and may control operation of the various components. For example, the various valves, switches, etc. may be actuatable based on commands from the controller 190. As discussed, interface panel 148 may additionally be in communication with the controller 190. Thus, the various operations may occur based on user input or automatically through controller 190 instruction.

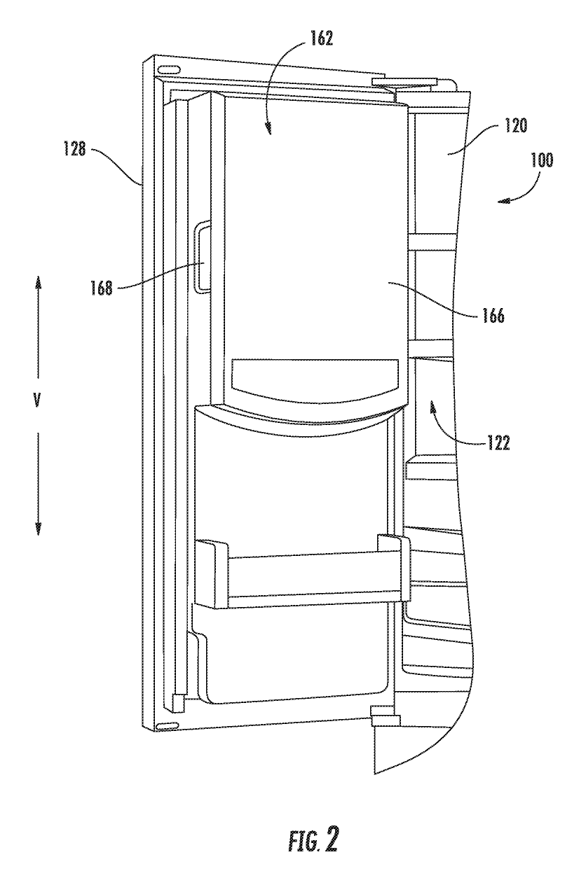

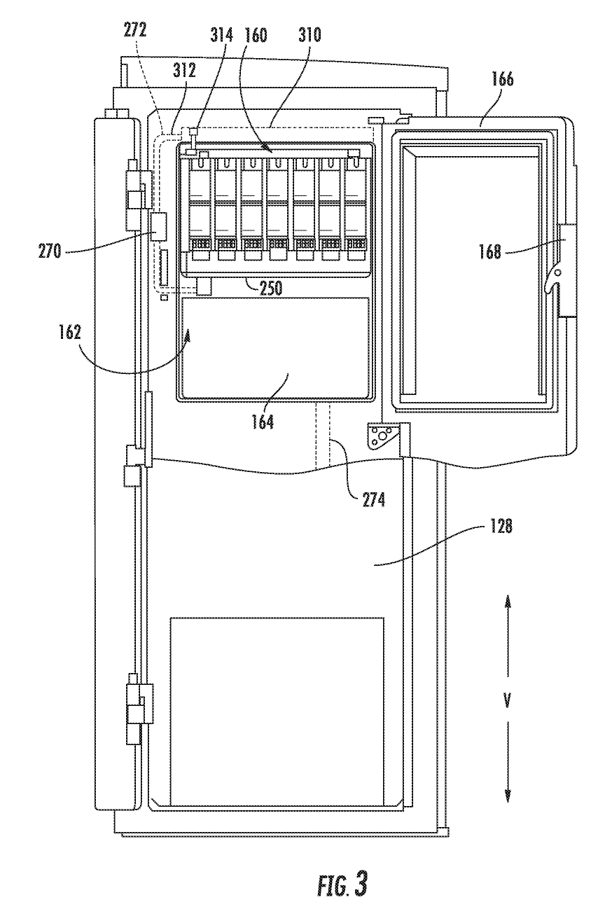

FIG. 2 provides a perspective view of a door of refrigerator doors 128. FIG. 3 provides an elevation view of refrigerator door 128 with an access door 166 shown in an open position. Refrigerator appliance 100 includes a sub-compartment 162 defined on refrigerator door 128. Sub-compartment 162 is often referred to as an “icebox.” Moreover, sub-compartment 162 extends into fresh food chamber 122 when refrigerator door 128 is in the closed position.

As may be seen in FIG. 3, an ice-making assembly 160 and an ice storage bin 164 are positioned or disposed within sub-compartment 162. Thus, ice is supplied to dispenser recess 150 (FIG. 1) from ice-making assembly 160 and/or ice storage bin 164 in sub-compartment 162 on a back side of refrigerator door 128. Chilled air from a sealed system (not shown) of refrigerator appliance 100 may be directed into ice-making assembly 160 in order to cool components of ice-making assembly 160. In particular, an evaporator 178, e.g., that is positioned at or within fresh food chamber 122 or freezer chamber 124, is configured for generating cooled or chilled air. A supply conduit 180, e.g., that is defined by or positioned within housing 120, extends between evaporator 178 and components of ice-making assembly 160 in order to cool components of ice-making assembly 160 and assist ice formation by ice-making assembly 160.

During operation of ice-making assembly 160, chilled air from the sealed system cools components of ice-making assembly 160 to or below a freezing temperature of liquid water. Thus, ice-making assembly 160 is an air cooled ice-making assembly. Chilled air from the sealed system also cools ice storage bin 164. In particular, air around ice storage bin 164 can be chilled to a temperature above the freezing temperature of liquid water, e.g., to about the temperature of fresh food chamber 122, such that ice cubes in ice storage bin 164 melt over time due to being exposed to air having a temperature above the freezing temperature of liquid water. In addition, ice-making assembly 160 may also be exposed to air having a temperature above the freezing temperature of liquid water. As an example, air from fresh food chamber 122 can be directed into sub-compartment 162 such that ice-making assembly 160 and/or ice storage bin 164 is exposed to air from fresh food chamber 122.

In optional embodiments, liquid water generated during melting of ice cubes in ice storage bin 164, is directed out of ice storage bin 164. For example, turning back to FIG. 1, liquid water from melted ice cubes is directed to an evaporation pan 172. Evaporation pan 172 is positioned within a mechanical compartment 170 defined by housing 120, e.g., at bottom portion 102 of housing 120. A condenser 174 of the sealed system can be positioned, e.g., directly, above and adjacent evaporation pan 172. Heat from condenser 174 can assist with evaporation of liquid water in evaporation pan 172. A fan 176 configured for cooling condenser 174 can also direct a flow air across or into evaporation pan 172. Thus, fan 176 can be positioned above and adjacent evaporation pan 172. Evaporation pan 172 is sized and shaped for facilitating evaporation of liquid water therein. For example, evaporation pan 172 may be open topped and extend across about a width and/or a depth of housing 120.

Access door 166 is hinged to refrigerator door 128. Access door 166 permits selective access to sub-compartment 162. Any manner of suitable latch 168 is configured with sub-compartment 162 to maintain access door 166 in a closed position. As an example, latch 168 may be actuated by a consumer in order to open access door 166 for providing access into sub-compartment 162. Access door 166 can also assist with insulating sub-compartment 162.

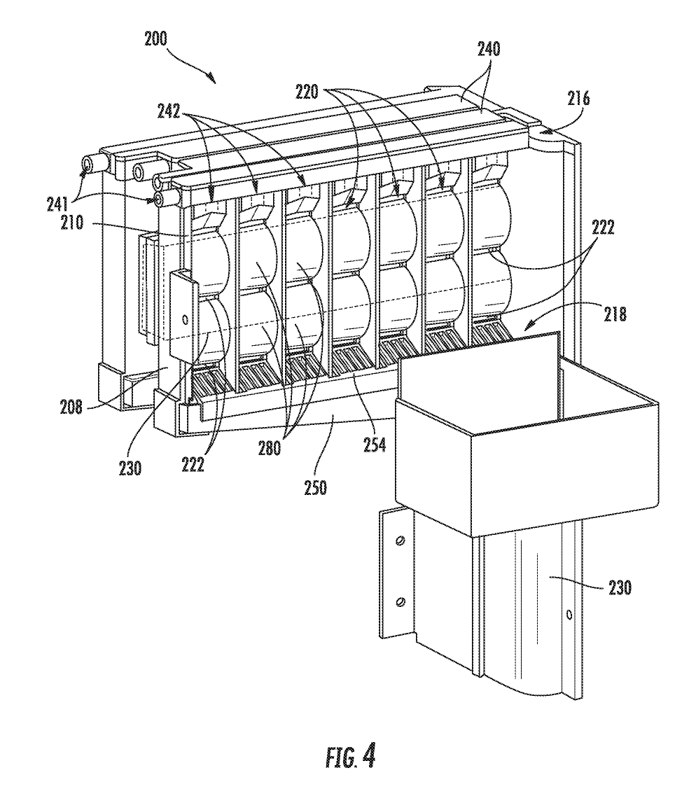

FIG. 4 provides a perspective view of an ice-making assembly 200 according to an exemplary embodiment of the present disclosure. Ice-making assembly 200 can be used in any suitable refrigerator appliance. For example, ice-making assembly 200 may be used in refrigerator appliance 100 (FIG. 1) as ice-making assembly 160.

As may be seen in FIG. 4, ice-making assembly 200 has an icemaker 208 that includes ice formation panels 210. Ice formation panels 210 generally extend between a top portion 216 and a bottom portion 218. Top and bottom portions 216 and 218 are, e.g., vertically, spaced apart from each other. Ice formation panel 210 also defines a plurality of channels 220. As shown, channels 220 may be positioned at or adjacent a front surface of ice formation panel 210. Ice formation panel 210 can be constructed of or with any suitable material. For example, ice formation panel 210 may be constructed of or with stainless steel.

A plurality of, e.g., horizontal, projections 222 may be disposed or positioned within channels 220. During ice formation, projections 222 assist with hindering or preventing bridging of ice cubes 280. Thus, projections 222 can assist with keeping ice cubes 280 separate or distinct. Optionally, projections 222 may be formed on ice formation panel 210. For example, projections 222 may be embossed on ice formation panel 210.

Ice-making assembly 200 also includes chilled air duct 230. Chilled air duct 230 is positioned at or adjacent to ice formation panel 210. Optionally, chilled air duct 230 is positioned opposite channels 220 on ice formation panel 210. Chilled air duct 230 may be configured or arranged for receiving a flow of chilled air, e.g., from supply conduit 180 and evaporator 178 (FIG. 1). During operation, chilled air within chilled air duct 230 can cool ice formation panel 210, e.g., to permit or facilitate ice cube formation on ice formation panel 210. Chilled air duct 230 can be constructed of or with any suitable material. For example, chilled air duct 230 may be constructed of or with molded plastic.

A water distribution manifold 240 is positioned at or adjacent top portion 216 of ice formation panel 210. Water distribution manifold 240 has or defines a one or more inlets 241 and outlets 242. Each outlet of outlets 242 is aligned with a respective one of channels 220. In particular, each outlet of outlets 242 may be positioned, e.g., directly, above the respective one of channels 220. Liquid water may flow through inlets 241, within water distribution manifold 240, and out of outlets 242 into channels 220. Due to chilled air within interior volume 232 of chilled air duct 230, ice formation panel 210 is chilled to or below the freezing temperature of water such that liquid water flowing within channels 220 can freeze on ice formation panel 210 and form ice cubes 280 on ice formation panel 210. Ice cubes 280 can have any suitable shape. For example, ice cubes 280 may be crescent shaped.

Returning to FIG. 3, a filtration cartridge 310 may be positioned upstream of the water distribution manifold 240, e.g., as a segment of a water recirculation line. A filter inlet 312 may be defined through one portion of filter cartridge while a filter outlet 314 is defined through another portion. In some embodiments, filter outlet 314 is directly connected in fluid communication with inlet 241. Generally, sediments and salts may be removed from water before it is directed to water distribution manifold 240. As will be described in detail below, one or more filter media may be contained within filtration cartridge 310. During use, e.g., ice making operations, water may be motivated from filter inlet 312 to filter outlet 314 and through filter media within filtration cartridge 310.

As illustrated, filtration cartridge 310 may be positioned within sub-compartment 162, e.g., within refrigerator door 128 and/or above water distribution manifold 240 along the vertical direction V. Advantageously, water within filtration cartridge may be maintained at a relatively low temperature, thereby enhancing the ice-making rate of ice-making assembly 160. Moreover, the pressure drop of fluid or water within filtration cartridge may be reduced.

Referring again to FIG. 4, ice-making assembly 200 can be exposed to or operate within air having a temperature greater than a freezing temperature of liquid water. Thus, liquid water within water distribution manifold 240 can be hindered from freezing during operation of ice-making assembly 200. However, as discussed above, chilled air within chilled air duct 230 can permit formation of ice cubes 280 on ice formation panel 210, e.g., despite ice-making assembly 200 being exposed to or operating within air having a temperature greater than a freezing temperature of liquid water.

A water collection sump 250 is positioned at bottom portion 218 of ice formation panel 210. In particular, water collection sump 250 may be positioned, e.g., directly, below channels 220 of ice formation panel 210. Thus, water collection sump 250 can receive liquid water runoff from channels 220 during operation of ice-making assembly 200. In optional embodiments, a grate 254 is also positioned at bottom portion 218 of ice formation panel 210. Grate 254 may be positioned, e.g., directly, above water collection sump 250. As shown, grate 254 is oriented for directing harvested ice cubes 280 away from water collection sump 250. For example, grate 254 may be sloped downwardly away from ice formation panel 210 such that harvested ice cubes 280 impact grate 254 rather than falling into water collection sump 250.

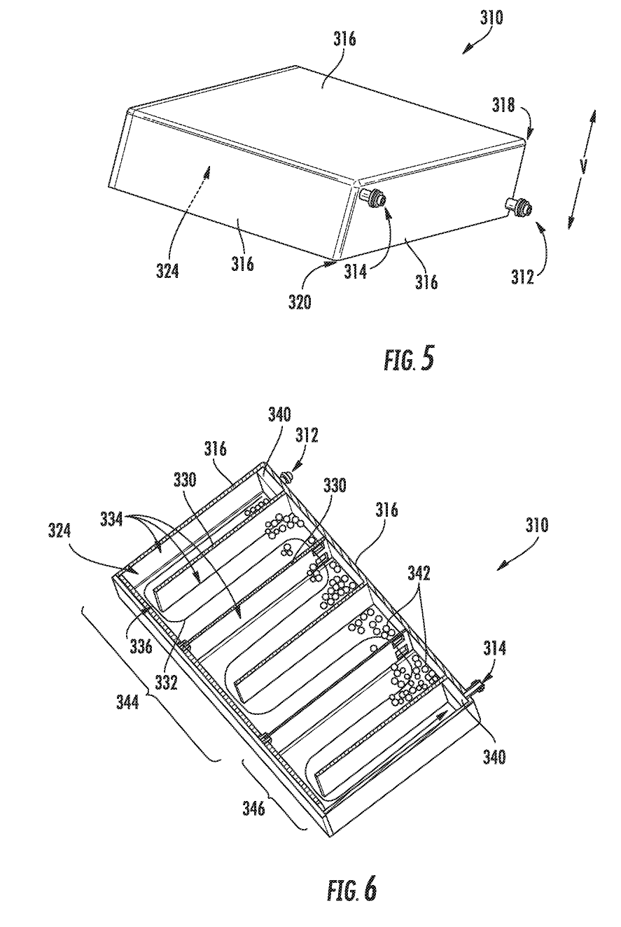

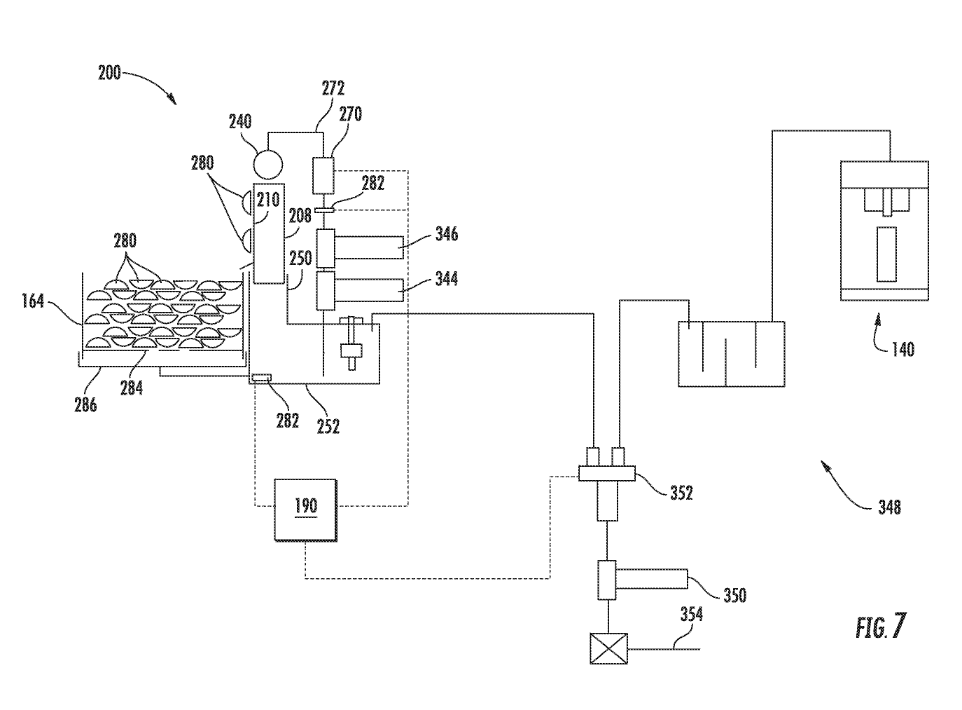

Turning now to FIGS. 5 and 6, some embodiments include a filtration cartridge 310. As shown, filtration cartridge 310 has one or more cartridge sidewalls 316 defining a media chamber 324. One or more divider walls 330 may extend within media chamber 324 to guide water therethrough. For instance, divider walls 330 may define a flow path 332 through media chamber 324, including one or more sub-chambers 334. An internal opening 336 may be defined between each sub-chamber 334, thereby directing water through multiple discrete sub-chambers 334 along flow path 332.

Cartridge sidewalls 316 may be sealed together as an impermeable body. For instance, cartridge sidewalls 316 may be formed an integral unitary structure or attached from discrete elements joined in a fluid seal (e.g., via sonic welding or adhesives). Media chamber 324 and/or divider walls 330 enclose one or more filtration media 342 configured to treat water within filtration cartridge 310. Although filtration media 342 is only shown within a portion of media chamber 324 for the sake of clarity, it is understood that filtration media may substantially fill the volume defined by media chamber 324 and/or divider walls 330.

As shown, a filter inlet 312 extends through at least one sidewall 316 at one location while a discrete filter outlet 314 extends through at least one sidewall 316 (e.g., the same sidewall or an alternate sidewall) at another location. Water may thus be forced through filter inlet 312 and into media chamber 324 before passing out of filtration cartridge 310 through filter outlet 314. In some embodiments, filter outlet 314 is defined above filter inlet 312, e.g., along the vertical direction V. For instance, filter outlet 314 may be located at a top portion 318 of a cartridge sidewall 316 while filter inlet 312 is defined below that location, e.g., at a bottom portion of the same cartridge sidewall 316. Advantageously, air introduced into media chamber 324 may escape through filter outlet 314. During operation, water may thus be forced across substantially all of the filtration media 342 within filtration cartridge 310. Optionally, one or more fibrous pads 340 may be positioned across filter inlet 312 and filter outlet 314. Fibrous pad 340 may be configured to permit the flow of water while restricting the passage of filtration media 342, thereby containing filtration media 342 within media chamber 324.

In some embodiments, filtration cartridge 310 includes a deionization filter 344 contained within a portion of media chamber 324, e.g., one or more sub-chambers 334. In some such embodiments, filtration media 342 includes anion resin and cation resin contained within a portion of filtration cartridge 310. Optionally, filtration media 342 may include a mixed-bed media of commingled anion and cation resin. The mixed-bed media is configured to remove dissolved solids, such as inorganic salts of sodium and chlorine ions.

In additional or alternative embodiments, filtration cartridge 310 includes an organic compound filter 346 contained within a portion of media chamber 324, e.g., one or more sub-chambers 334. Specifically, organic compound filter 346 may be contained within a sub-chamber 334 downstream from deionization filter 344. In certain embodiments, organic compound filter 346 is an activated carbon filter. Filtration media 342 may thus include activated carbon particulate downstream from deionization filter 344. For instance, filtration media 342 within one or more sub-chambers 334 downstream from deionization filter 344 may be activated carbon particulate. Advantageously, organic material introduced into the water of filtration assembly, e.g., at an anion resin, may thus be removed from water before the water passes to ice formation panel 210 (FIG. 4).

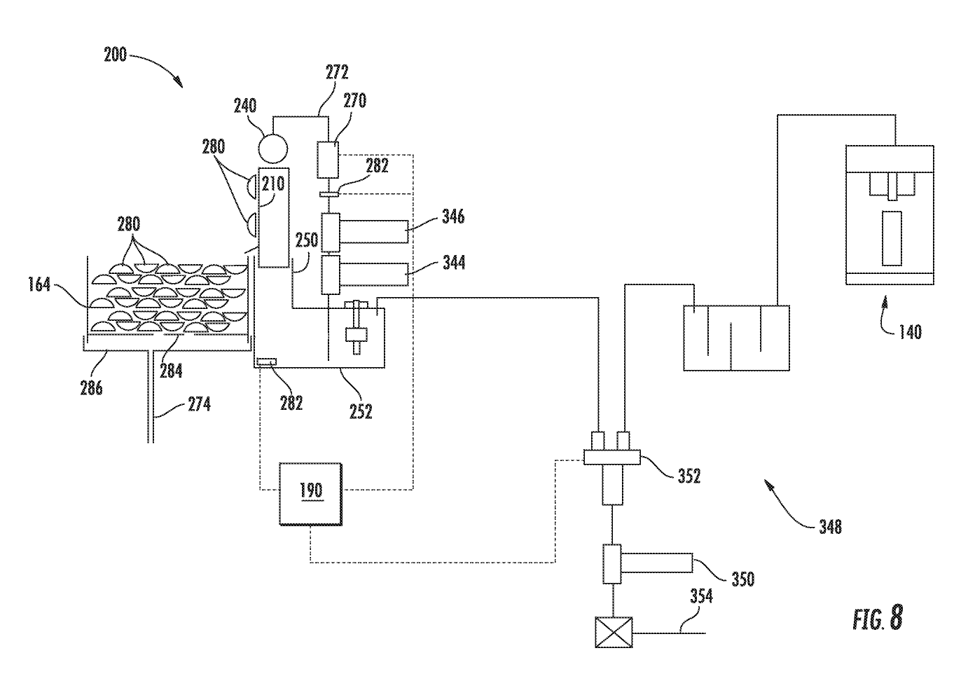

Turning now to FIG. 7, a schematic view of an example water distribution assembly 348 is provided. Water distribution assembly 348 may include ice-making assembly 200 and dispensing assembly 140 as described above. In some embodiments, a prefilter cartridge 350 and divider valve 352 are positioned upstream of ice-making assembly 200 and dispensing assembly 140. Prefilter cartridge 350 may be an activated carbon filter configured to remove sediment and/or organic material from water supplied thereto. Water received from a water source 354 (e.g., domestic water grid or well) may thus be forced through prefilter cartridge 350 before being directed to one or both of ice-making assembly 200 or dispensing assembly 140.

Downstream of divider valve 352, water may be introduced to water reservoir 252. As described above, water reservoir 252 may be positioned below icemaker 208. A water recirculation line 272 extends from water reservoir 252, e.g., in the vertical direction, to icemaker 208. Specifically, water recirculation line 272 may extend into the volume defined by water reservoir 252. Water recirculation line 272 may further extend in fluid communication between water reservoir 252 and water distribution manifold 240 of icemaker 208. A pump 270 is positioned along water recirculation line 272 to motivate water from within reservoir 252 to water distribution manifold 240 through water recirculation line 272.

Deionization filter 344 may be positioned along water recirculation line 272. Specifically, deionization filter 344 may be positioned upstream from the water distribution manifold 240 (e.g., in fluid communication therewith). Deionization filter 344 may include an anion resin and a cation resin, as described above. Optionally deionization filter 344 may be a mixed-bed filter wherein the anion and cation resins are commingled.

In some embodiments, organic compound filter 346 is positioned along water recirculation line 272, e.g., as an activated carbon filter. Organic compound filter 346 may be in fluid communication between the deionization filter 344 and the water distribution manifold 240. In other words, organic compound filter 346 may be downstream from deionization filter 344. As described above, organic compound filter 346 may be contained within the same filtration cartridge 310 (FIG. 6) as deionization filter 344. Alternatively, organic compound filter 346 may include a discrete cartridge body spaced apart from deionization filter 344 along water recirculation line 272.

As illustrated, one or more conductivity sensors 282 may be provided in fluid communication with water reservoir 252. Specifically, a conductivity sensor 282 may be positioned within water reservoir 252. Additionally or alternatively, a conductivity sensor 282 may be positioned along water recirculation line 272, e.g., downstream of deionization filter 344 and/or organic compound filter 346. Conductivity sensor(s) 282 may be operably connected (e.g., electrically coupled) to controller 190. Moreover, conductivity sensor(s) 282 may be configured to detect a value of fluid conductivity of water within assembly 200. Based on conductivity values detected at conductivity sensor(s) 282, controller 190 may determine that deionization filter 344 has reached the end of a filter lifecycle (e.g., and should be replaced). Optionally, controller 190 may be configured to automatically halt icemaker 208 or ice-making operations according to one or more conductivity values detected at conductivity sensor(s) 282. For instance, if controller 190 determines that a detected conductivity value exceeds a threshold conductivity value, controller 190 may halt or cease operation of icemaker 208.

As described above, ice-making operations may include directing water from a water distribution manifold 240 and across ice formation panel 210. A portion of the water across ice formation panel 210 may freeze into ice cubes 280. Excess water from ice formation panel 210 may fall to sump 250 and water reservoir 252 positioned below ice formation panel 210. Once frozen, ice cubes 280 are directed to ice cube storage bin 164, which is in communication with ice formation panel 210. Optionally ice cube storage bin 164 may be positioned below ice formation panel 210, e.g., adjacent to water reservoir 252.

In some embodiments, ice cube storage bin 164 includes a perforated support plate 284. Water melted from ice cubes 280 may fall through perforated support plate 284. A catch pan 286 may be positioned below ice cube storage bin 164, e.g., directly below perforated support plate 284, to receive the water. Optionally, catch pan 286 may be in fluid communication with water reservoir 252. Water melted from ice cubes 280 may thus pass from ice cube storage bin 164 to water reservoir 252.

As illustrated in FIG. 8, alternative embodiments of ice-making assembly 200 may include a drain conduit 274 extending in fluid communication with ice cube storage bin 164. Specifically, drain conduit 274 may extend in fluid communication between ice cube storage bin 164 and evaporation pan 172 (FIG. 1). Optionally, drain conduit 274 may extend from catch pan 286. In some embodiments, drain conduit 274 connects ice cube storage bin 164 and evaporation pan 172 in fluid communication with each other. Melted water from ice cubes 280 may thus pass as liquid water from ice-making assembly 200 to evaporation pan 172.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

1. An ice-making assembly for a refrigeration appliance, the ice-making assembly comprising:
an icemaker for making ice cubes, the icemaker comprising a water distribution manifold and an ice formation panel;
an ice cube storage bin in communication with the ice formation panel to receive ice cubes therefrom;
a water reservoir positioned below the ice formation panel to receive excess water flow;
a water recirculation line in fluid communication between the water reservoir and the water distribution manifold;
a deionization filter positioned along the water recirculation line upstream from the water distribution manifold; and
an organic compound filter positioned along the water recirculation line in fluid communication between the deionization filter and the water distribution manifold,
wherein the deionization filter is a mixed bed filter comprising an anion resin and a cation resin, and wherein the deionization filter is positioned above the water distribution manifold.

2. The ice-making assembly of claim 1, wherein the organic compound filter is an activated carbon filter.

3. (canceled)

4. The ice-making assembly of claim 1, further comprising a fluid pump positioned along the water recirculation line to motivate water therethrough.

5. The ice-making assembly of claim 1, further comprising a catch pan positioned below the ice cube storage bin to receive water melted from ice cubes within the ice cube storage bin.

6. The ice-making assembly of claim 5, further comprising a drain conduit extending in fluid communication between the catch pan and the evaporation pan.

7. The ice-making assembly of claim 1, further comprising a conductivity sensor in fluid communication with the water reservoir.

8. An ice-making assembly for a refrigeration appliance comprising an evaporation pan, the ice-making assembly comprising:
an icemaker for making ice cubes, the icemaker comprising a water distribution manifold and an ice formation panel;
an ice cube storage bin in communication with the ice formation panel to receive ice cubes therefrom;
a water reservoir positioned below the ice formation panel to receive excess water flow;
a water recirculation line in fluid communication between the water reservoir and the water distribution manifold;
a deionization filter positioned along the water recirculation line upstream from the water distribution manifold; and
a drain conduit extending in fluid communication between the ice cube storage bin and the evaporation pan,
wherein the deionization filter is a mixed bed filter comprising an anion resin and a cation resin, and wherein the deionization filter is positioned above the water distribution manifold.

9. The ice-making assembly of claim 8, further comprising an activated carbon filter positioned along the water recirculation line in fluid communication between the deionization filter and the water distribution manifold.

10. (canceled)

11. The ice-making assembly of claim 8, further comprising a fluid pump positioned along the water recirculation line to motivate water therethrough.

12. The ice-making assembly of claim 8, further comprising a conductivity sensor positioned along the water recirculation line.

13. The ice-making assembly of claim 8, further comprising a conductivity sensor positioned within the water reservoir.

14. A refrigerator appliance comprising:
a cabinet defining a chilled chamber;
a door mounted to the cabinet; and
an ice-making assembly mounted to the door, the ice-making assembly comprising
an icemaker for making ice cubes, the icemaker comprising a water distribution manifold and an ice formation panel,
an ice cube storage bin in communication with the ice formation panel to receive ice cubes therefrom,
a water reservoir positioned below the ice formation panel to receive a volume of excess water flow;
a water recirculation line in fluid communication between the water reservoir and the water distribution manifold;
a deionization filter positioned along the water recirculation line upstream from the water distribution manifold; and
an organic compound filter positioned along the water recirculation line in fluid communication between the deionization filter and the water distribution manifold, wherein the deionization filter is a mixed bed filter comprising an anion resin and a cation resin, and wherein the deionization filter is positioned above the water distribution manifold within the door.

15. The refrigerator appliance of claim 14, wherein the organic compound filter is an activated carbon filter.

16. (canceled)

17. The refrigerator appliance of claim 14, further comprising a fluid pump positioned along the water recirculation line to motivate water therethrough.

18. The refrigerator appliance of claim 14, further comprising a catch pan positioned below the ice cube storage bin to receive water melted from ice cubes within the ice cube storage bin.

19. The refrigerator appliance of claim 14, further comprising a drain conduit and an evaporation pan, the evaporation pan positioned within a mechanical chamber defined by the cabinet, the drain conduit extending in fluid communication between the ice cube storage bin and the evaporation pan.

20. The refrigerator appliance of claim 14, further comprising a conductivity sensor in fluid communication with the water reservoir.
